(19) United States
(12) Patent Application Publication
(10) Pub. No.: US 2015/0242872 A1
(43) Pub. Date: Aug. 27, 2015

(54) MANAGING MARKETING IMPRESSIONS WITH CONSUMER REWARDS

(71) Applicant: International Business Machines Corporation, Armonk, NY (US)

(72) Inventors: Pietro Mazzoleni, New York City, NY (US); Pavankumar Murali, Haverstraw, NY (US); Hironori Takeuchi, Yokohama-shi (JP); Roman Vaculin, Bronxville, NY (US)

(73) Assignee: International Buisness Machines Corporation, Armonk, NY (US)

(21) Appl. No.: 14/189,486

(22) Filed: Feb. 25, 2014

(51) Int. Cl. G06Q 30/02; G06Q 50/00

(52) U.S. Cl. CPC G06Q 30/0211; G06Q 30/0217; G06Q 50/01

(57) ABSTRACT

A method, apparatus, and computer program product for managing marketing impressions. An apparatus identifies utility of a seller and utility of a user. The apparatus generates an offer of a reward based on the utility of the seller and the utility of the user. The offer of the reward is for performing a social marketing task. The social marketing task is for generating a first number of marketing impressions to achieve a set of objectives of the seller. The apparatus activates the reward for the user when the social marketing task is completed. The social marketing task is completed when the apparatus determines that the user has accepted the offer and the performing of the social marketing task has generated the first number of marketing impressions.

### BACKGROUND

1. Field

The disclosure relates generally to an improved data processing system and, in particular, to a data processing system for managing marketing impressions. Still more particularly, the present disclosure relates to a system and method for managing marketing impressions with consumer rewards for social marketing tasks.

2. Description of the Related Art

Rewards are used regularly to encourage consumers to patronize a particular business or to buy a particular product or service. These rewards are commonly known as “rewards.” An increasing number of retailers are using electronic rewards to reach consumers quickly and easily. Electronic rewards are particularly effective because these types of rewards are free to send to consumers.

Electronic rewards take a number of different forms including, for example, a mobile reward. A “mobile reward” or “mobile coupon,” as used herein, refers to a reward configured to be displayed by a user on a mobile device. Mobile rewards may be received by a consumer via email or by navigating a website of a business of interest. Moreover, social media websites, group deal platforms, and other entities provide mobile rewards for consumers for a variety of different products and services. Mobile rewards are particularly popular for businesses due to their high redemption rate compared to some traditional methods of couponing. Mobile rewards also increase a business's exposure to potential consumers.

Typically, mobile rewards entitle consumers to receive a commercial advantage on a product or service. For instance, mobile rewards may provide discounts, free shipping, or allow a consumer to try a product for free. Mobile rewards benefit both the business, which makes more sales, and the consumer, who receives the commercial advantage. Accordingly, increasing the redemption rate of mobile rewards is desirable.

Consumers gain access to mobile rewards in a variety of different ways. Some consumers sign up for particular offers from retailers of interest, while other consumers gain access to mobile rewards through untargeted marketing campaigns. In some cases, consumers may receive a high volume of untargeted mobile rewards.

Consumers receive untargeted mobile rewards for reasons unrelated to their likelihood of redemption. As a result, these types of mobile rewards may not be of interest to the consumers who receive them. Consumers may find these offers distracting, which, in some cases, may even decrease the likelihood of the consumer buying the product.

One approach to increasing the redemption rate of mobile rewards is to provide a targeted marketing campaign. With a targeted marketing campaign, businesses send mobile rewards to particular consumers based on the consumers' shopping history, preferences, geographic area, and other indicators of likelihood to redeem the mobile reward.

The targeted marketing technique, however, may not increase the redemption rate of mobile rewards as much as desired. For example, consumers may not wish to receive mobile rewards at all and block or delete emails including such rewards. Additionally, a history of buying a particular product does not necessarily mean that the consumer will continue to buy the same product, a similar product, or purchase from the same business more than once, making targeted rewards based on shopping history less effective than desired. Therefore, it would be desirable to have a method, apparatus, and computer program product that take into account at least some of the issues discussed above.

### SUMMARY

In one illustrative embodiment, a method, apparatus, and computer program product for managing marketing impressions is disclosed. An apparatus identifies utility of a seller and utility of a user. The apparatus generates an offer of a reward based on the utility of the seller and the utility of the user. The offer of the reward is for performing a social marketing task. The social marketing task is for generating a first number of marketing impressions to achieve a set of objectives of the seller. The apparatus activates the reward for the user when the social marketing task is completed. The social marketing task is completed when the apparatus determines that the user has accepted the offer and the performing of the social marketing task has generated the first number of marketing impressions.

### BRIEF DESCRIPTION OF THE DRAWINGS

FIG. 1 is a block diagram of a marketing environment in accordance with an illustrative embodiment;

FIG. 2 is an illustration of a data flow for negotiating an offer between a reward modeler and a user in accordance with an illustrative embodiment;

FIG. 3 is a block diagram of a set of characteristics in accordance with an illustrative embodiment;

FIG. 4 is an illustration of a block diagram of a set of objectives in accordance with an illustrative embodiment;

FIG. 5 is an illustration of a data flow for identifying an offer for a user in accordance with an illustrative embodiment;

FIG. 6 is an illustration of a graph for a utility of a seller for a user and a complexity of a social marketing task in accordance with an illustrative embodiment;

FIG. 7 is an illustration of a data flow of identifying an offer in accordance with an illustrative embodiment;

FIG. 8 is an illustration of a flowchart of a process for managing rewards in accordance with an illustrative embodiment;

FIG. 9 is an illustration of a flowchart of a process for negotiating an offer between a user and a seller in accordance with an illustrative embodiment; and

FIG. 10 is an illustration of a data processing system in accordance with an illustrative embodiment.

### DETAILED DESCRIPTION

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the present invention may take the form of a computer program product embodied in one or more computer-readable medium(s) (or media) having computer-readable program code embodied thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described below with reference to flowchart illustrations and/or block diagrams of methods, apparatuses (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments recognize and take into account a number of different considerations. For example, the illustrative embodiments recognize and take into account that some currently used data processing systems for rewards do not provide personalized rewards based on characteristics of a consumer. Moreover, the illustrative embodiments recognize and take into account that a consumer's social reach has the potential to increase visibility and sales of a product. In this illustrative example, a “social reach” is the number of people that view information presented by the consumer, the number of people who identify they like the information presented by the consumer, and the number of people who re-post the information presented by the consumer. This information may be presented by at least one of sending the information, posting the information, or otherwise providing the information for other people. The concept of social reach is particularly applicable to social media sites, blogs, instant messaging, and review boards; however, social reach also may be determined by a consumer's other in-person or telephonic activities.

The illustrative embodiments further recognize and take into account that some currently used data processing systems for rewards also do not provide an ability for a consumer to select a reward to be received based on the consumer performing a particular social marketing task. As an example, existing systems do not include an ability to provide personalized rewards for consumers based on the consumer's social reach. As another example, the existing systems do not allow a consumer to pick a reward from multiple rewards that may be present based on performing a social marketing task.

Thus, illustrative embodiments provide a method, apparatus, and computer program product for managing rewards. A request from a user for an offer may be received by a processor unit. The processor unit may identify a reward and a social marketing task to be performed by the user for an activation of the reward in response to the request for the offer. The offer of the reward and the social marketing task may be sent by the processor unit to the user. The reward for the user may be activated by the processor unit when the social marketing task is completed.

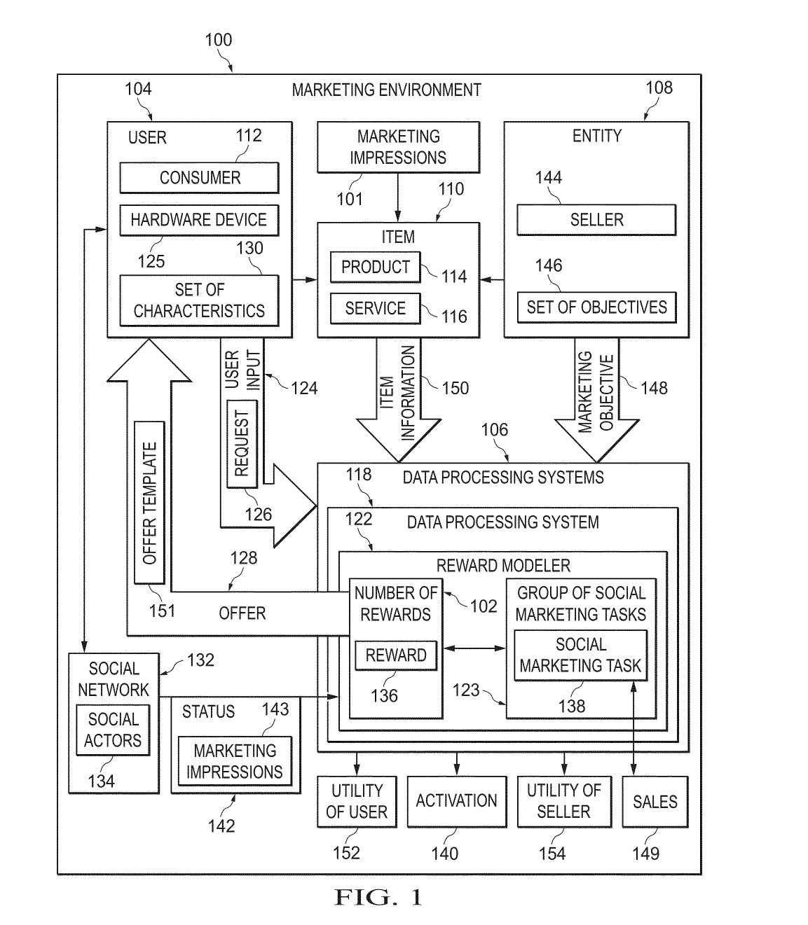

With reference now to the figures and, in particular, with reference to FIG. 1, a block diagram of a marketing environment is depicted in accordance with an illustrative embodiment. Marketing environment 100 is an illustrative example of an environment for managing marketing impressions 101 with number of rewards 102 for user 104. In these illustrative examples, a marketing impression is a display of a message about an item. As used herein, a “number of,” when used with reference to items, means one or more items. For example, a number of rewards is one or more rewards.

As depicted, marketing environment 100 includes user 104, a number of data processing systems 106, entity 108, and item 110. In this illustrative example, user 104 is consumer 112. User 104 may have an interest in item 110. For instance, user 104 may be interested in purchasing item 110. In another example, user 104 may be interested in trying item 110 as a sample. In this illustrative example, item 110 may be selected from at least one of product 114, service 116, or some other suitable item.

In this depicted example, data processing system 118 is an example of one data processing system in data processing systems 106. Data processing system 118 includes hardware and software. As depicted, data processing system 118 includes reward modeler 122. Reward modeler 122 is an application running in data processing system 118. Reward modeler 122 identifies number of rewards 102 and group of social marketing tasks 123.

In this depicted example, reward modeler 122 is configured to receive user input 124 from user 104. User input 124 may be request 126 for offer 128 from reward modeler 122. User input 124 may be received by reward modeler 122 from hardware device 125 operated by user 104. Hardware device 125 may be selected from one of a computer, a tablet computer, a mobile phone, or some other suitable type of hardware device.

As illustrated, user 104 may send request 126 based on set of characteristics 130 about user 104. Set of characteristics 130 includes features or qualities about user 104 related to item 110, entity 108, another item or entity, or a combination thereof.

A “set,” as used herein, includes one or more items. In this illustrated example, set of characteristics 130 about user 104 includes one or more characteristics. Set of characteristics 130 about user 104 is described in more detail with reference to FIG. 3.

In this illustrative example, user 104 has social network 132. Social network 132 is a social structure made up of a group of social actors 134 and ties between social actors 134 in the group. A social actor in social actors 134 is an entity that performs an activity related to social network 132. In other words, a social actor is a member of social network 132.

Social actors 134 may be selected from at least one of an individual, an organization, a political group, a government, or some other suitable actor. For instance, when social actors 134 are individuals, social actors 134 send messages to each other over social network 132. In another example, social actors 134 may be part of a political group that campaigns together. In still another example, social actors 134 may be part of social network 132 that is a book club. In this case, social actors 134 meet in person to discuss reading materials.

Social actors 134 are connected in a number of different ways. For instance, social actors 134 may be connected through a social media website, a subscription, a computer network, a geographical location, an area of interest, or by some other suitable means. Social network 132 may be an electronic network in some illustrative examples, while in other illustrative examples, social network 132 may be a group of social actors 134 who meet in person, conduct regular conference calls, or communicate in some other suitable manner.

In this illustrative example, social media refers to the means of interaction among entities in which the entities create, share, and exchange information and ideas over social network 132. In this illustrative example, social media is a group of Internet-based applications that allow social actors 134 to exchange content generated by social actors 134. For example, social media may be selected from collaborative projects, blogs, microblogs, content communities, virtual gaming worlds, virtual social worlds, and other suitable types of media.

As depicted, in response to request 126 from user 104 for offer 128, reward modeler 122 identifies reward 136 in number of rewards 102 and social marketing task 138 in group of social marketing tasks 123 to be performed by user 104. Social marketing task 138 is performed by user 104 for activation 140 of reward 136. When reward modeler 122 performs activation 140 of reward 136, reward 136 is then usable for user 104. In other words, reward modeler 122 activates reward 136 such that reward 136 is usable for user 104.

In this illustrative example, reward 136 is an incentive for user 104 to purchase or try item 110. Reward 136 takes a number of different forms in this depicted example. For instance, reward 136 may be selected by reward modeler 122 from at least one of a discount, free shipping, product 114, service 116, free admission, or some other suitable reward. In other words, reward 136 may be an incentive such as a discount or free shipping on product 114 or service 116, or may be product 114 or service 116 itself. In other illustrative examples, reward 136 may be free admission to a concert, a campaign gala, a sporting event, or some other suitable type of event, depending on the interests of user 104.

As illustrated, social marketing task 138 is an activity that user 104 needs to perform to receive activation 140 of reward 136 from reward modeler 122. Social marketing task 138 is typically focused on promoting product 114, service 116, or a brand associated with entity 108 in this illustrative example. Social marketing task 138 may be individual or collaborative and involves social network 132 for user 104. A collaborative activity is an activity involving user 104 and one or more additional social actors 134.

Social marketing task 138 is a number of steps performed by user 104 with respect to social network 132. In other words, social marketing task 138 is a piece of work performed by user 104 in social network 132. Social marketing task 138 is identified by reward modeler 122 such that reward modeler 122 can track whether social marketing task 138 has been completed by user 104.

Social marketing task 138 may take various forms. For instance, social marketing task 138 may be selected from at least one of liking a page, sending a message, commenting on product 114 or service 116, writing a review, posting on a blog, contacting an entity, organizing a meeting, trying product 114, trying service 116, visiting a website, or performing some other suitable activity.

When social marketing task 138 is a collaborative activity, user 104 may contact one or more of social actors 134 in social network 132 to complete social marketing task 138. In one illustrative example, social marketing task 138 may be sending ten messages to social actors 134 in social network 132 about product 114.

In another example, social marketing task 138 may be an individual activity and include writing a review about service 116. Social marketing task 138 for user 104 is identified based on set of characteristics 130 of user 104 in this depicted example.

In this illustrative example, reward modeler 122 sends offer 128 of reward 136 and social marketing task 138 to user 104. User 104 may then accept offer 128, reject offer 128, or propose a new offer. Once user 104 accepts offer 128, user 104 performs social marketing task 138.

Periodically, reward modeler 122 determines status 142 of social marketing task 138. In some illustrative examples, status 142 of social marketing task 138 may indicate that social marketing task 138 has been completed, social marketing task 138 is in process, or social marketing task 138 has not been started by user 104. In other illustrative examples, status 142 may indicate a number of contacts made, a percent completion, or some other suitable metric for monitoring the progress of social marketing task 138. In this illustrated example, status 142 includes marketing impressions 143. As depicted, marketing impressions 143 is a number of times a message about item 110 was displayed associated with social marketing task 138.

Reward modeler 122 also may determine sales 149 of item 110 or other items from entity 108. In this illustrative example, sales 149 are sales made due to user 104 completing social marketing task 138. In one example, sales 149 are sales of item 110 generated from a message sent to social actors 134 in social network 132. In another illustrative example, sales 149 are sales of all items from entity 108 attributed to offer 128 for user 104.

After user 104 completes social marketing task 138, reward modeler 122 performs activation 140 for reward 136 for user 104. User 104 may then redeem reward 136. In some illustrative examples, activation 140 of reward 136 may include sending an email or text message to user 104. In other illustrative examples, reward 136 may be associated with a profile of user 104 to be redeemed at any time on a website for entity 108.

In this illustrative example, entity 108 is seller 144. Seller 144 may be attempting to sell item 110 in this illustrative example. Seller 144 may be an individual, a company, or some other suitable entity.

As depicted, reward modeler 122 may identify reward 136 and social marketing task 138 based on more than set of characteristics 130 of user 104. For instance, in this illustrative example, reward modeler 122 identifies reward 136 and social marketing task 138 to be performed by user 104 for activation 140 of reward 136 based on set of objectives 146 for entity 108.

Set of objectives 146 includes marketing objective 148 in this illustrative example. Other objectives in set of objectives 146 are discussed in greater detail with respect to FIG. 4. In this depicted example, entity 108 sends marketing objective 148 to reward modeler 122 for use in selecting social marketing task 138 to be performed by user 104.

As illustrated, reward modeler 122 also may use item information 150 about item 110 to identify social marketing task 138 and reward 136 for user 104. Item information 150 includes at least one of an identification, a marketing status, a cost, an availability, a popularity, and other suitable information about item 110. Item information 150 is stored in a database in this illustrative example.

In this illustrative example, marketing status may indicate whether item 110 needs more advertising. Cost and availability of item 110 may determine what type of reward 136 is most beneficial for both user 104 and entity 108. Popularity is an indicator of the demand for item 110. Item information 150 aids reward modeler 122 in providing the most suitable offer 128 for user 104 and entity 108.

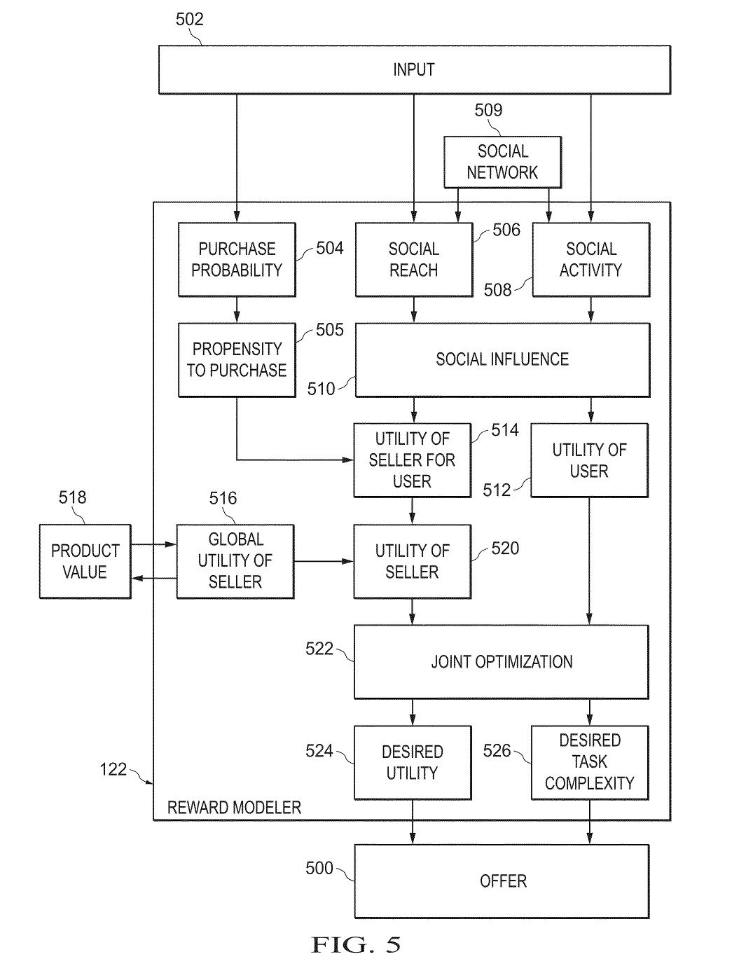

In the illustrated example, reward modeler 122 may generate offer 128 for reward 136 to perform social marketing task 138 based on utility of user 152. Utility of user 152 is a value placed on what user 104 can offer for helping to achieve set of objectives 146. Utility of user 152 may be based on set of characteristics 130 of user 104. Utility of user 152 for user 104 is described in more detail with reference to FIG. 5. As depicted, reward modeler 122 may further generate offer 128 for reward 136 to perform social marketing task 138 based on utility of seller 154. Utility of seller 154 is a value to seller 144 associated with achieving set of objectives 146. For example, utility of seller 154 may be based on a value associated by seller 144 with making sales of item 110 as a function of number of rewards 102 that can be offered to user 104. Utility of seller 154 for seller 144 is described in more detail with reference to FIG. 5.

The illustration of reward modeler 122 in marketing environment 100 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, reward modeler 122 is configured to communicate with user 104 and seller 144 in a process for selecting reward 136. In these illustrative examples, reward modeler 122 may determine a reward that fits the needs of user 104, while providing seller 144 with a competitive advantage.

In another illustrative example, reward modeler 122 identifies number of rewards 102 and group of social marketing tasks 123 corresponding to number of rewards 102. Reward modeler 122 is configured to rank rewards in number of rewards 102 based on a value to user 104. For example, a reward for a five percent discount would rank lower than a reward for a ten percent discount.

After identifying number of rewards 102 and group of social marketing tasks 123, reward modeler 122 then presents number of rewards 102 and group of social marketing tasks 123 corresponding to number of rewards 102 to user 104. In some cases, the display may be a ranked display. In this depicted example, reward modeler 122 may present number of rewards 102 and group of social marketing tasks 123 to user 104 by displaying number of rewards 102 and group of social marketing tasks 123 on a display device in data processing system 118. The display device is hardware in this illustrative example.

Reward modeler 122 displays number of rewards 102 and group of social marketing tasks 123 such that user 104 may select reward 136 and social marketing task 138. In this illustrative example, number of rewards 102 and group of social marketing tasks 123 corresponding to number of rewards 102 are all suitable options for item 110 based on at least one of set of characteristics 130, set of objectives 146, or item information 150.

User 104 then selects reward 136 and social marketing task 138 from number of rewards 102 and group of social marketing tasks 123, respectively, and sends user input 124 back to reward modeler 122. Reward modeler 122 identifies reward 136 and social marketing task 138 in response to user input 124. In some cases, reward modeler 122 identifies reward 136 and social marketing task 138 in response to user input from a member of social network 132 (i.e., one of social actors 134) requesting offer 128 be sent to user 104, user input from a third party requesting offer 128 be sent to user 104, and from other suitable entities.

In still other illustrative examples, reward modeler 122 does not identify one or more of number of rewards 102 and group of social marketing tasks 123. Instead, in response to request 126 by user 104, reward modeler 122 sends offer template 151 to user 104. Offer template 151 is a data structure in which user 104 may input information for offer 128. In other words, offer template 151 is a data structure in which the actual value of at least one of the reward and the corresponding social marketing task is not determined. For instance, offer template 151 may offer a percent discount for item 110. User 104 fills in the desired discount and sends the information back to reward modeler 122. In another example, user 104 may fill in the desired social marketing task, such as sending 20 messages to friends on social network 132.

In still other illustrative examples, user 104 fills in both a desired reward and a desired social marketing task. Reward modeler 122 uses this information in identifying reward 136 and social marketing task 138 for user 104.

In another example, reward modeler 122 does not send offer template 151 to user 104 in response to receiving request 126. Rather, user 104 inputs a desired reward and a desired social marketing task into offer template 151 in some other manner. For instance, user 104 may use an existing offer template included on a website. The completed offer template 151 is then sent to reward modeler 122 as part of user input 124.

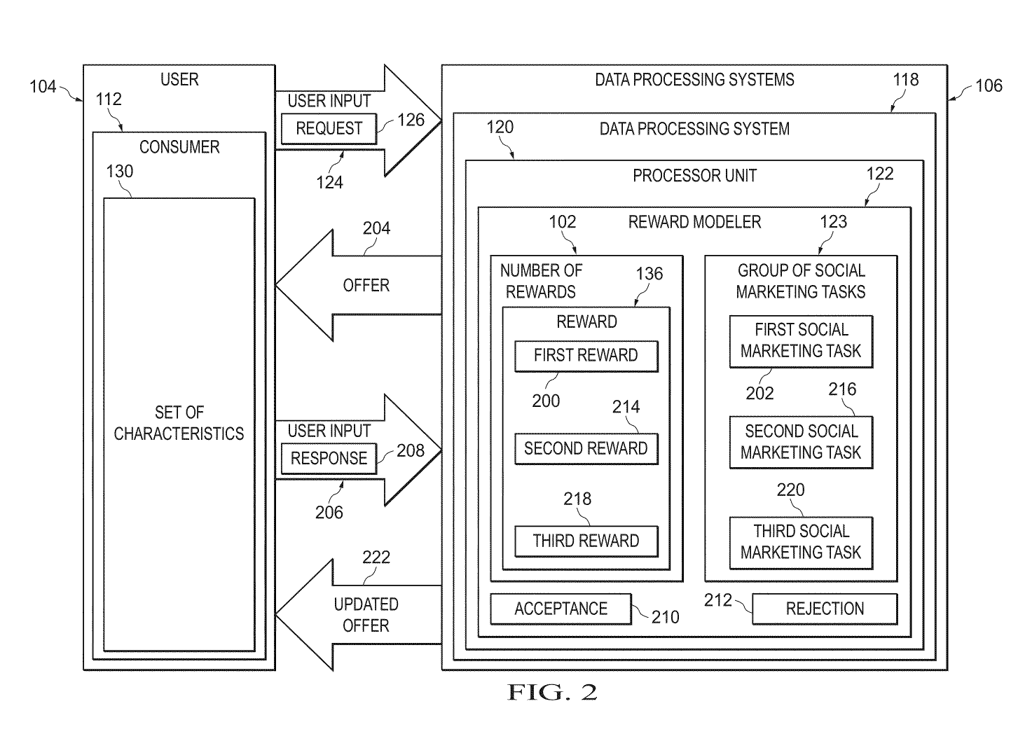

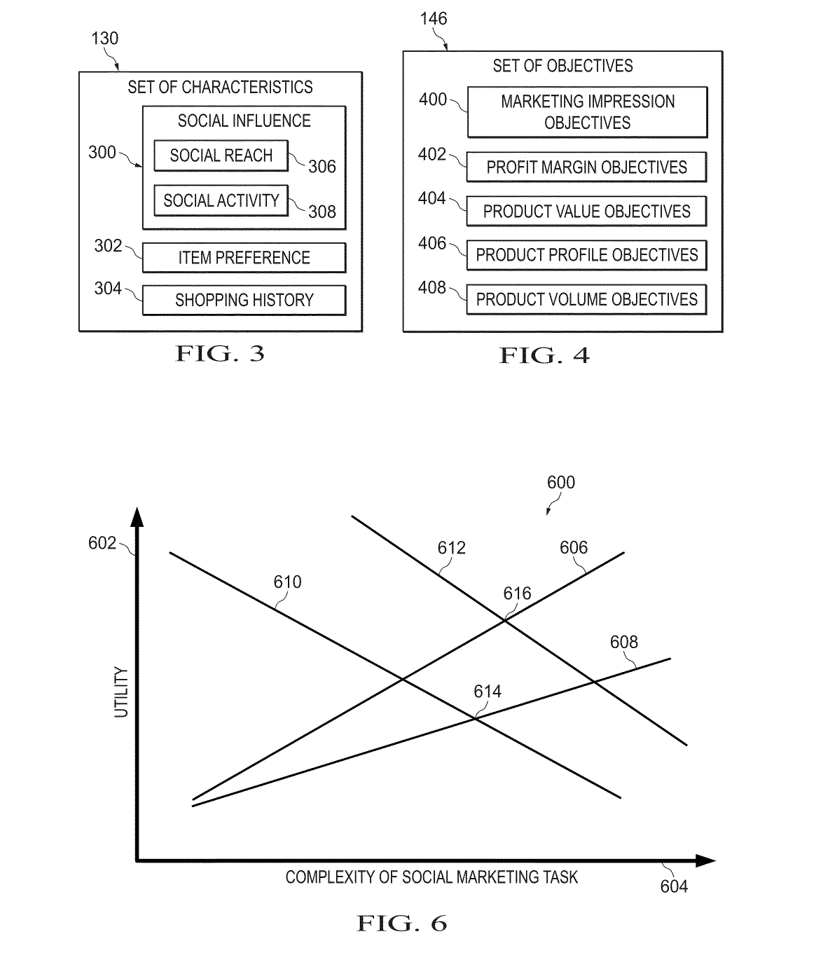

Turning next to FIG. 2, an illustration of a data flow for negotiating an offer between a reward modeler and a user is depicted in accordance with an illustrative embodiment. In this illustrative example, reward modeler 122 is shown in communication with user 104 from FIG. 1. Reward modeler 122 communicates with user 104 to select offer 204 in this illustrative example.

As discussed above in FIG. 1, user 104 sends user input 124 to reward modeler 122. User input 124 is request 126 in this illustrative example. In response, reward modeler 122 identifies first reward 200 in number of rewards 102 and first social marketing task 202 associated with first reward 200 for user 104 based on request 126. First social marketing task 202 is an example of social marketing task 138 in FIG. 1. Reward modeler 122 then sends offer 204, including first reward 200 and first social marketing task 202, to user 104.

As depicted, user 104 sends user input 206 back to reward modeler 122. User input 206 takes the form of response 208 in this illustrative example. Response 208 may indicate acceptance 210, rejection 212, or some other suitable response regarding offer 204.

In this depicted example, at least one of first reward 200 or first social marketing task 202 is not amenable to user 104. Accordingly, user 104 sends response 208 with a counteroffer. In particular, user 104 sends response 208, including second reward 214 and second social marketing task 216. Second reward 214 and second social marketing task 216 are a proposed reward and a proposed social marketing task, respectively. Second social marketing task 216 is an example of social marketing task 138 in FIG. 1.

Reward modeler 122 receives user input 206, including second reward 214 and second social marketing task 216. In this illustrative example, reward modeler 122 may identify at least one of acceptance 210, rejection 212, or some other response to second reward 214 and second social marketing task 216. In some illustrative examples, reward modeler 122 identifies third reward 218 and third social marketing task 220 to be performed by user 104. Third reward 218 and third social marketing task 220 associated with third reward 218 form updated offer 222. Third social marketing task 220 is an example of social marketing task 138 in FIG. 1.

As illustrated, reward modeler 122 sends at least one of acceptance 210, rejection 212, or updated offer 222 to user 104. User 104 may accept, reject, or counteroffer in the same manner as described above. This process continues until user 104 and reward modeler 122 have found an agreeable offer.

With the use of reward modeler 122, user 104 may select an offer for a reward and a social marketing task. Reward modeler 122 may take into account at least one of set of characteristics 130 of user 104, set of objectives 146 of entity 108, or item information 150 from FIG. 1 when generating updated offer 222 as well as subsequent offers for user 104 in this illustrative example. The negotiation of an offer is only an example of one of the functions performed by reward modeler 122 with respect to user 104 and is not meant to limit the manner in which at least one of offer 204, updated offer 222, or additional offers may be generated.

With reference next to FIG. 3, a block diagram of a set of characteristics is depicted in accordance with an illustrative embodiment. In this depicted example, an example of characteristics that may be present in set of characteristics 130 of user 104 from FIG. 1 is shown. Set of characteristics 130 may be used by reward modeler 122 to identify reward 136 and social marketing task 138 for user 104.

As illustrated, set of characteristics 130 comprises at least one of social influence 300, item preference 302, and shopping history 304. Social influence 300 may be a numerical value, while item preference 302 and shopping history 304 may include more detailed data about user 104. Other characteristics in addition to or in place of the ones shown also may be present in set of characteristics 130 in other illustrative examples.

In this illustrative example, social influence 300 includes social reach 306 and social activity 308. Social reach 306 is the ability of user 104 to connect, message, or otherwise engage with other social actors 134 in social network 132. Social activity 308 is an activity performed in relation to social actors 134 in social network 132. In some illustrative examples, social reach 306 and social activity 308 may be unrelated to social network 132. In this case, user 104 may be communicating with an entity outside of social network 132.

As depicted, social reach 306 is calculated using the size of social network 132 of user 104, the method in which messages propagate between social actors 134 in social network 132, or a combination thereof. For example, when user 104 has a large number of friends and communications occur through instant messaging or posts on the webpage of user 104, user 104 may have a higher value for social reach 306 than a user who communicates via telephone to a small number of group members. In other words, social value 306 is related to the number of social actors 134 from FIG. 1 that can be exposed to the messages of user 104.

Social activity 308 includes details of the frequency and type of activity user 104 engages in on social network 132. For instance, social activity 308 may be data indicating how many posts user 104 has posted on public sites and the topics of each post. As another example, social activity 308 may be data about how often user 104 logs on to a particular website.

In this illustrative example, item preference 302 includes data about the preferences of user 104. For instance, item preference 302 may indicate that user 104 prefers a particular brand of item 110 from FIG. 1. In another illustrative example, item preference 302 is determined by user input 124 from FIG. 1 in the form of a survey.

As depicted, shopping history 304 comprises details about the shopping history of user 104. Shopping history 304 may include the types of products and services user 104 buys regularly and other information about the shopping habits of user 104.

In this depicted example, reward modeler 122 uses social influence 300, item preference 302, and shopping history 304 of user 104 when generating reward 136 and social marketing task 138 in FIG. 1. In this manner, reward 136 and social marketing task 138 are personalized for user 104.

Turning now to FIG. 4, an illustration of a block diagram of a set of objectives is depicted in accordance with an illustrative embodiment. In this depicted example, a more detailed illustration of set of objectives 146 for entity 108 from FIG. 1 is shown.

As depicted, set of objectives 146 are objectives of seller 144 in FIG. 1 with respect to item 110. In this illustrative example, item 110 is product 114. Set of objectives 146 comprise at least one of marketing impression objectives 400, profit margin objectives 402, product value objectives 404, product profile objectives 406, or product volume objectives 408. Other objectives in addition to or in place of the ones shown may be present in set of objectives 146 in other illustrative examples.

In this depicted example, marketing impression objectives 400 may include a number of marketing impressions. A “marketing impression,” as used herein, is the number of times a message is displayed to a user, whether or not the user takes action based on the advertisement. The message may be an advertisement for item 110 in FIG. 1, a promotion for product 114, a logo of seller 144, or some other suitable type of message. For instance, when user 104 is shopping online, an advertisement may be displayed for product 114. That advertisement, viewed by user 104, is one marketing impression, regardless of whether user 104 clicks on the advertisement.

In another illustrative example, a marketing impression occurs when a user views a message from seller 144 on a billboard. Marketing impression objectives 400 may be a desired value in this illustrative example. Marketing impression objectives 400 change based on the identity of product 114, based on the category for product 114, or based on some other suitable factor. Marketing impression objectives 400 desired by seller 144 may be based on a cost of each marketing impression, as well as other business-related factors. In this illustrative example, the cost of each marketing impression is the cost of reaching user 104 with the message. For example, each time a message for product 114 is displayed for user 104 on a website, seller 144 is charged a fee. Reward modeler 122 uses marketing impression objectives 400 to identify social marketing task 138 for user 104 to perform to receive activation 140 of reward 136 from FIG. 1.

As illustrated, profit margin objectives 402 include the desired profit margin of seller 144 for product 114. For example, profit margin objectives 402 include profit as a percentage of selling price for product 114. Profit margin objectives 402 are used as input by reward modeler 122 to identify reward 136 and social marketing task 138 to present to user 104.

In this depicted example, product value objectives 404 may include the desired value of product 114 to seller 144, the actual value of product 114, and other suitable objectives. Product value objectives 404 may be the desired cost of product 114 or may be another indicator of value for product 114. For example, product value objectives 404 indicate the amount of money or capital that seller 144 is willing to pay to purchase or manufacture product 114 costs. Product value objectives 404 are used by reward modeler 122 to determine which rewards are amenable to seller 144. As an example, a reward that discounts product 114 to a price below a desired product value in product value objectives 404 would not be desirable for seller 144 in some cases.

In another illustrative example, product value objectives 404 may not include the desired cost of product 114. Instead, product value objectives 404 may include the value of product 114 with respect to other items sold by seller 144, the importance of selling product 114 with respect to an overall business plan of seller 144, or some other suitable type of indicator of value. In still other illustrative examples, product value objectives 404 may include a categorization for product 114, such as how much product 114 should be advertised, its relative popularity, or some other suitable type of categorization.

As illustrated, product profile objectives 406 include objectives based on categorizations of product 114. There categorizations may be attributed to whether product 114 needs advertising, is popular, should be sold as a temporary promotion, will be sunset soon, and other suitable categorizations. Reward modeler 122 also uses product profile objectives 406 to determine rewards. For instance, for a product that will sunset soon, product profile objectives 406 may indicate that the price of product 114 should be deeply discounted.

In this illustrative example, product volume objectives 408 include the desired number of product 114 to be sold. In other words, product volume objectives 408 include the amount of product 114 that seller 144 desires to sell in a given time frame. For example, when seller 144 desires to sell a higher product volume reward modeler 122 may identify different types of rewards than if seller 144 does not indicate a higher value for the product volume. As one example, reward modeler 122 identifies a two-for-one reward or a buy-one-get-one reward for reward 136 on product 114 such that more of product 114 is purchased.

With reference next to FIG. 5, an illustration of a data flow for identifying an offer for a user is depicted in accordance with an illustrative embodiment. In this illustrative example, reward modeler 122 generates offer 500 for a user in marketing environment 100 in FIG. 1. In particular, reward modeler 122 generates offer 500 for product 114 from a seller in FIG. 1 in this illustrative example. Offer 500 is one example of offer 128 as shown and described with reference to FIG. 1.

In this depicted example, input 502 is received by reward modeler 122. Input 502 may include at least one of an identification of the user, an identification of product 114, offer template 151 from the user, social influence 300, item preference 302, shopping history 304, or other suitable types of input. Input 502 also may include a request for offer 500.

From input 502, reward modeler 122 identifies purchase probability 504, social reach 506, and social activity 508. Social reach 506 and social activity 508 are examples of social reach 306 and social activity 308 from FIG. 3.

Purchase probability 504 is the probability that the user will purchase product 114. Purchase probability 504 is determined based on input 502. For example, purchase probability 504 may be computed as a function of past purchase behavior of the user, history of clicks on related advertisements, items viewed by the user, duration for which the user viewed items, item viewing frequency, demographics of the user, or other suitable information about the user related to probability of the user to purchase items. From purchase probability 504, propensity to purchase 505 is identified. As used herein, a probability is a likelihood of something happening. For example, purchase probability of a user for an item may be a real number between 0 and 1 identifying likelihood that a user will purchase the item.

Reward modeler 122 identifies social reach 506 and social activity 508 of the user from information received by social network 509 based on input 502. For example, when input 502 includes an identification of the user, reward modeler 122 uses this identification to access social network 509 of the user. For example, social reach 506 may be calculated based on how many friends user 104 has in a social network.

As depicted, reward modeler 122 then identifies social influence 510 from social reach 506 and social activity 508. Reward modeler 122 next identifies utility of user 512 from social influence 510 and utility of seller for user 514 from purchase probability 504 and social influence 510. Utility of user 512 in FIG. 5 is an example of utility of user 152 in FIG. 1.

In this illustrative example, utility of user 512 is a function of the user's expected utility for an offer. For instance, in one example, utility of user 512 is a value that represents acceptable price points at which the user may be willing to perform a social marketing task to receive a reward for product 114. Utility of user 512 is expressed as U_c=f(price of product, quality of product, brand equity)=f(g (effort), h (effort), m (effort))=F (effort). In this illustrative example, the price of the product is the market price of product 114, the quality of product is a category for product 114, and brand equity is a function of current customer base loyalty toward items in the brand, purchase propensity in the absence of a discount, and how many substitutable items are available in the market. In other words, utility of user 512 is a function of effort. Effort, in this depicted example, is the amount of time or energy the user is willing to invest in order to obtain a reward. In this illustrative example, utility of user 512 also reflects the importance of keeping or gaining the user as a buyer to increase the return on investment marketing, as well as to improve business.

Utility of seller for user 514 is based on a set of characteristics for the user including social reach 506, social activity 508, purchase probability 504, or a combination thereof. In this illustrative example, utility of seller for user 514 reflects the utility that the seller gains if the user performs a social marketing task for product 114.

In this depicted example, reward modeler 122 also calculates global utility of seller 516 from product value 518 of product 114. Product value 518 may be received from a database in this illustrative example.

As illustrated, global utility of seller 516 can be expressed as U_r=π_r, where π is profit. Assuming that demand is linearly correlated to the price (p_i) of each product in a portfolio, demand is a function a−bp, where p is price vector, then U_r=(a−bp)*p. Increasing the global utility of a seller corresponds to determining p_i such that the profit (π) over the portfolio is increased. The demand can be estimated using historical purchase data.

For example, reward modeler 122 may use a transaction history of the seller to model historical demand for product 114. In some examples, global utility of seller 516 may be a utility of the seller for an entire product portfolio, depending on the price of the products in the portfolio.

Using global utility of seller 516 and utility of seller for user 514, reward modeler 122 then identifies utility of seller 520. Utility of seller 520 in FIG. 5 is an example of utility of seller 154 in FIG. 1. Utility of seller 520 is a value to the seller associated with achieving objectives of the seller. Utility of seller 520 may be determined based on a value associated by the seller with making sales of items as a function of rewards that can be offered to users.

As illustrated, reward modeler 122 performs joint optimization 522 using utility of seller 520 and utility of user 512 to identify desired utility 524 and desired task complexity 526 for offer 500. Joint optimization 522 is performed to generate a number of personalized offers for the user. Joint optimization 522 of utility of seller 520 and utility of user 512 is performed for different values of p to obtain the right set of prices for a user and product 114 that maximizes the user's overall worth to seller 144.

In this depicted example, desired utility 524 is a specified objective of the seller, the user, or a combination of seller and user. Desired utility 524 is one or both of an amount of utility the seller wants the user to have and an amount of utility the user wants the seller to have. Desired task complexity 526 is an amount of complexity desired by the seller, the user or a combination of the seller and user. For example, desired task complexity 526 may be a specification of a number of reposts of a message about an item to provide marketing impressions for the item. In this illustrative example, reward modeler 122 identifies offer 500 from desired utility 524 and desired task complexity 526 and sends offer 500 to the user.

With the use of reward modeler 122, seller 144 may more easily determine a business plan or marketing budget based on the results of the process described in FIG. 5. This marketing budget may take into account various scenarios run by reward modeler 122, sales 149 in FIG. 1, and other factors. Seller 144 may increase or decrease its marketing budget based on data generated by reward modeler 122. Moreover, seller 144 can target advertising more effectively based on at least one of set of characteristics 130, set of objectives 146, and item information 150. For instance, using reward modeler 122, seller 144 may determine the geographical location of users which results in the highest likelihood that sales will occur. In another example, seller 144 may determine future demand for product 114 or service 116.

Turning next to FIG. 6, an illustration of a graph for a utility of a seller for a user and a complexity of a social marketing task is depicted in accordance with an illustrative embodiment. In this depicted example, graph 600 has x-axis 602 and y-axis 604. X-axis 602 represents a complexity of a social marketing task, while y-axis 604 represents a utility of a seller for a user. Graph 600 is a graph of the utility of seller 144 with respect to the complexity of social marketing task 138 from FIG. 1.

In an illustrative example, the y-axis represents utility of seller for user 514 from FIG. 5. The complexity of the social marketing task may be a representation of the difficulty of the social marketing task, the length of the social marketing task, some other suitable factor, or a combination thereof. For example, the complexity of the social marketing task may be based on a number of marketing impressions to be performed by user 104 from FIG. 1.

As depicted, line 606 shows a utility of a seller to a first user. As the utility of the seller for the first user increases, the complexity of the social marketing task the first user is willing to perform also increases. Line 608 shows a utility of a seller to a second user. Similar to line 606, as the utility of the seller for the second user increases, the complexity of the social marketing task the second user is willing to perform also increases; however, this increase is at a slower rate than that of the first user.

In this illustrative example, line 610 represents a perceived reward for the second user. Line 612 represents a perceived reward for the first user in this illustrative example. Equilibrium point 614 is present for the second user, while equilibrium point 616 is present for the first user in this illustrative example. Equilibrium point 614 occurs where line 610 and line 608 intersect. In a similar fashion, equilibrium point 616 occurs where line 606 and line 612 intersect. Equilibrium point 614 and equilibrium point 616 each represent the utility and the complexity of the social marketing task that is optimal for the second user and the first user, respectively.

The complexity value at equilibrium point 616 corresponds to desired task complexity 526 for the first user, while the utility value at equilibrium point 616 corresponds to desired utility 524 from FIG. 5 for the first user. The complexity value at equilibrium point 614 corresponds to desired task complexity 526 for the second user, while the utility value at equilibrium point 614 corresponds to desired utility 524 for the second user. These values are used by reward modeler 122 in FIG. 1 to identify offer 500 in FIG. 5 for the first user, the second user, a number of additional users, or a combination thereof. In this manner, reward modeler 122 provides offer 500 that is optimized for both the user and the seller.

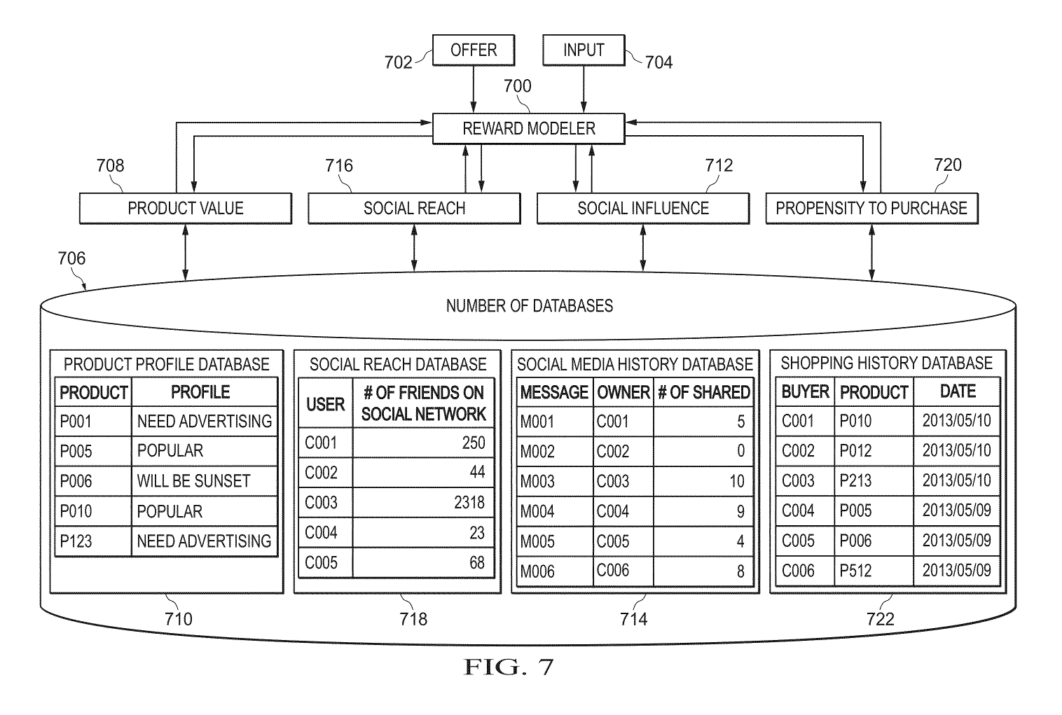

Referring now to FIG. 7, an illustration of a data flow of identifying an offer is depicted in accordance with an illustrative embodiment. In this depicted example, reward modeler 700 identifies offer 702 from input 704 from a user and information in number of databases 706. For instance, offer 702 may be generated for user 104 in FIG. 1. In particular, offer 702 may be generated by reward modeler 700 running on data processing system 118 in FIG. 1.

In this illustrative example, reward modeler 700 is an example of reward modeler 122 in FIG. 1. A database in number of databases 706 may be in the same physical location or a different physical location than reward modeler 700.

As illustrated, a user selects a product and an offer template. The product is an example of product 114, while the offer template is an example of offer template 151 in FIG. 1. The selection of the offer and the product template may be part of input 704 in this illustrative example.

Reward modeler 700 receives input 704 with user identification, product identification, and the offer template. Reward modeler 700 sends a request for product value 708, which includes the product identification. Based on product profile database 710 in number of databases 706, product value 708 is identified.

In this illustrative example, product profile database 710 includes categories for each product such as, for example, without limitation, “need advertising,” “popular,” “will be sunset,” and other suitable categories. The “need advertising” category indicates that seller 144 in FIG. 1 desires to increase the advertising for the product. The “popular” category indicates that the product is popular and does not need increased advertising. The “will be sunset” category indicates that this product may be going out of stock or out of production.

In this illustrative example, reward modeler 700 also requests social influence 712. Reward modeler 700 sends user identification with the request. From the user identification, social media history database 714 sends social influence 712 for the user to reward modeler 700. Social media history database 714 includes information about the messages posted on social network 132 in FIG. 1 and the corresponding user. For instance, social media history database 714 may indicate the number of messages that were shared by the user, as well as the content of those messages. Social media history database 714 may be accessed on social network 132.

As depicted, reward modeler 700 requests social reach 716 using the user identification. Social reach database 718 provides social reach 716 to reward modeler 700. In particular, social reach database 718 provides a number of friends on social network 132.

In this illustrative example, reward modeler 700 requests propensity to purchase 720 from shopping history database 722. The request includes the user identification and the product identification. Propensity to purchase 720 may indicate the most recent date the user purchased a product. In this illustrative example, shopping history database 722 tracks the transactions of the user including the date and product type.

Reward modeler 700 uses product value 708, social reach 716, social influence 712, and propensity to purchase 720 to generate offer 702 for the user. Offer 702 includes a reward and a corresponding social marketing task in this illustrative example.

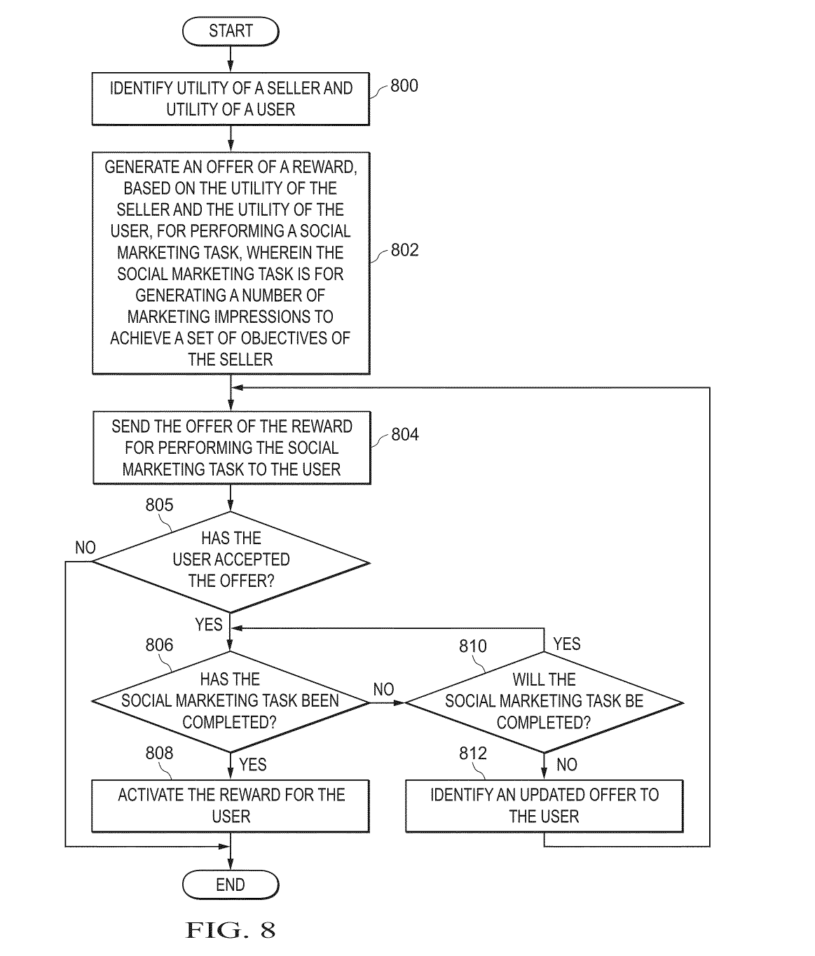

With reference next to FIG. 8, an illustration of a flowchart of a process for managing rewards is depicted in accordance with an illustrative embodiment. The steps illustrated in FIG. 8 are examples of steps that may be used to generate offer 128 with reward 136 and social marketing task 138 in FIG. 1. These steps may be implemented in data processing systems 106 in FIG. 1 and in other data processing systems. For example, the different steps may be performed by reward modeler 122 in FIG. 1.

The process begins by identifying utility of a seller and utility of a user (step 800). In this illustrative example, the seller in this process is an example of seller 144 in FIG. 1 and the user is an example of user 104 in FIG. 1. The utility of seller is an example of utility of seller 154 in FIG. 1 and the utility of user is an example of utility of user 152 in FIG. 1.

Next, the process generates an offer of a reward, based on the utility of the seller and the utility of the user, for performing a social marketing task, wherein the social marketing task is for generating a number of marketing impressions to achieve a set of objectives of the seller (step 802). The offer of the reward for performing the social marketing task is an example of offer 128 of reward 136 for performing social marketing task 138 in FIG. 1. The number of marketing impressions is an example of marketing impressions 101 in FIG. 1.

Thereafter, the offer of the reward for performing the social marketing task is sent to the user (step 804). In this depicted example, reward modeler 122 sends offer 128 to user 104. In step 804, reward modeler 122 may present offer 128 to user 104 on a display device.

A determination is then made as to whether the user has accepted the offer (step 805). If the user has refused the offer the process terminates. If the user accepted the offer, a determination is then made as to whether the social marketing task has been completed (step 806). For example, reward modeler 122 monitors status 142 to determine whether social marketing task 138 has been completed.

If the social marketing task has been completed, the reward is activated for the user (step 808) with the process terminating thereafter. For instance, reward modeler 122 sends activation 140 of reward 136 to user 104.

If the social marketing task has not been completed, the process determines whether the social marketing task will be completed (step 810). In this illustrative example, based on set of characteristics 130 of user 104, reward modeler 122 determines whether social marketing task 138 will be completed. If the social marketing task will not be completed, the process identifies an updated offer to the user (step 812), with the process returning to step 804. If the social marketing task will be completed, the process returns to step 806 as described above.

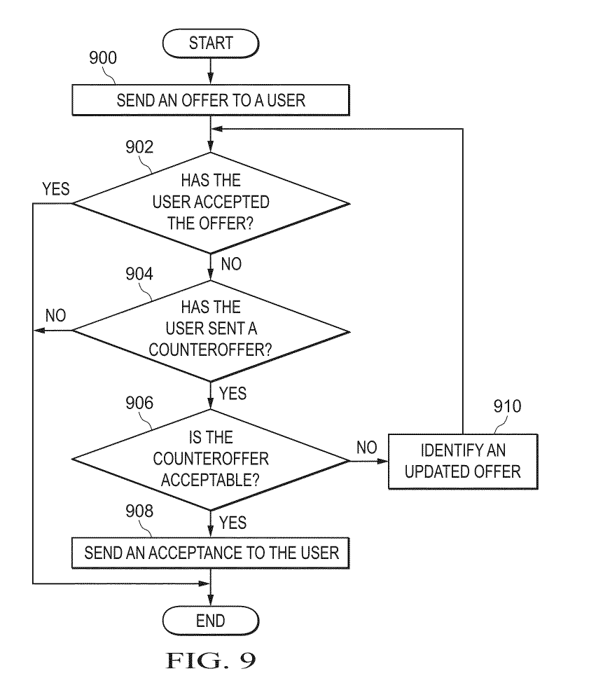

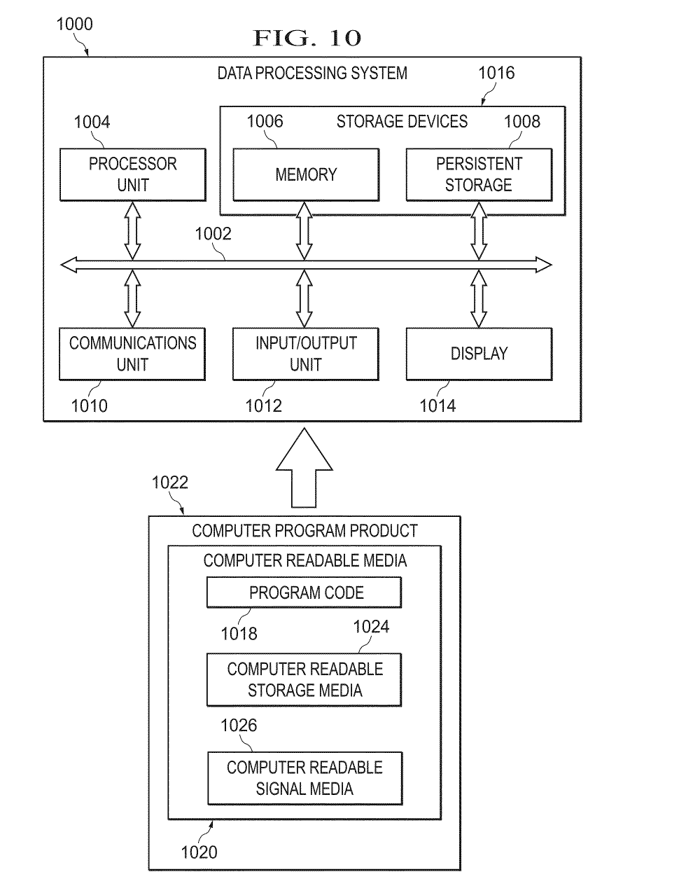

Referring now to FIG. 9, an illustration of a flowchart of a process for negotiating an offer between a user and a seller is depicted in accordance with an illustrative embodiment. The steps illustrated in FIG. 9 are examples of steps that may be used to generate offer 204 and updated offer 222 in FIG. 2. These steps may be implemented in data processing systems 106 in FIG. 1 and in other data processing systems. For example, the different steps may be performed by reward modeler 122 in FIG. 1 and FIG. 2.

The process begins by sending an offer to a user (step 900). For example, offer 204 may be sent in response to user input 124 in FIG. 1 or may be sent at some other suitable time. Next, a determination is made as to whether the user has accepted the offer (step 902). If the user has accepted the offer, the process terminates.

If the user has not accepted the offer, the process then determines whether the user has sent a counteroffer (step 904). In this illustrative example, reward modeler 122 receives the counteroffer in response 208 from user 104. If the user has not sent a counteroffer, the process terminates.

If the user has sent a counteroffer, the process determines whether the counteroffer is acceptable (step 906). In step 906, reward modeler 122 determines whether the counteroffer is acceptable based on set of objectives 146 of entity 108. If the counteroffer is acceptable, an acceptance is sent to the user (step 908), with the process terminating thereafter.

If the counteroffer is not acceptable, the process identifies an updated offer (step 910). For example, reward modeler 122 identifies updated offer 222 for user 104. The process then returns to step 902 as described above.

Turning now to FIG. 10, an illustration of a data processing system is depicted in accordance with an illustrative embodiment. Data processing system 1000 is an example of a data processing system that may be used to implement data processing systems 106 in FIG. 1. In particular, data processing system 1000 is an example of data processing system 118 running reward modeler 122 in FIG. 1.

In this illustrative example, data processing system 1000 includes communications framework 1002, which provides communications between processor unit 1004, memory 1006, persistent storage 1008, communications unit 1010, input/output (I/O) unit 1012, and display 1014. In these examples, communications framework 1002 may be a bus system.

Processor unit 1004 serves to execute instructions for software that may be loaded into memory 1006. Processor unit 1004 may be one of a number of processor units configured to execute instructions.

Processor unit 1004 may be a number of processors, a multi-processor core, or some other type of processor, depending on the particular implementation. Further, processor unit 1004 may be implemented using a number of heterogeneous processor systems in which a main processor is present with secondary processors on a single chip. As another illustrative example, processor unit 1004 may be a symmetric multi-processor system containing multiple processors of the same type.

Memory 1006 and persistent storage 1008 are examples of storage devices 1016. A storage device is any piece of hardware that is capable of storing information, such as, for example, without limitation, data, program code in functional form, and/or other suitable information either on a temporary basis and/or a permanent basis. Storage devices 1016 may also be referred to as computer-readable storage devices in these examples. Memory 1006, in these examples, may be, for example, a random access memory or any other suitable volatile or non-volatile storage device. Persistent storage 1008 may take various forms, depending on the particular implementation.

For example, persistent storage 1008 may contain one or more components or devices. For example, persistent storage 1008 may be a hard drive, a flash memory, a rewritable optical disk, a rewritable magnetic tape, or some combination of the above. The media used by persistent storage 1008 also may be removable. For example, a removable hard drive may be used for persistent storage 1008.

Communications unit 1010, in these examples, provides for communications with other data processing systems or devices. In these examples, communications unit 1010 is a network interface card. Communications unit 1010 may provide communications through the use of either or both physical and wireless communications links.

Input/output unit 1012 allows for input and output of data with other devices that may be connected to data processing system 1000. For example, input/output unit 1012 may provide a connection for user input through a keyboard, a mouse, and/or some other suitable input device. Further, input/output unit 1012 may send output to a printer. Display 1014 provides a mechanism to display information to a user.

Instructions for the operating system, applications, and/or programs may be located in storage devices 1016, which are in communication with processor unit 1004 through communications framework 1002. In these illustrative examples, the instructions are in a functional form on persistent storage 1008. These instructions may be loaded into memory 1006 for execution by processor unit 1004. The processes of the different embodiments may be performed by processor unit 1004 using computer-implemented instructions, which may be located in a memory, such as memory 1006.

These instructions are referred to as program code, computer-usable program code, or computer-readable program code that may be read and executed by a processor in processor unit 1004. The program code in the different embodiments may be embodied on different physical or computer-readable storage media, such as memory 1006 or persistent storage 1008.

Program code 1018 is located in a functional form on computer-readable media 1020 that is selectively removable and may be loaded onto or transferred to data processing system 1000 for execution by processor unit 1004. Program code 1018 and computer-readable media 1020 form computer program product 1022 in these examples. In one example, computer-readable media 1020 may be computer-readable storage media 1024 or computer-readable signal media 1026. Computer-readable storage media 1024 may include, for example, an optical or magnetic disk that is inserted or placed into a drive or other device that is part of persistent storage 1008 for transfer onto a storage device, such as a hard drive, that is part of persistent storage 1008. Computer-readable storage media 1024 also may take the form of a persistent storage, such as a hard drive, a thumb drive, or a flash memory, that is connected to data processing system 1000. In some instances, computer-readable storage media 1024 may not be removable from data processing system 1000. In these examples, computer-readable storage media 1024 is a physical or tangible storage device used to store program code 1018 rather than a medium that propagates or transmits program code 1018. Computer-readable storage media 1024 is also referred to as a computer-readable tangible storage device or a computer-readable physical storage device. In other words, computer-readable storage media 1024 is a media that can be touched by a person.

Alternatively, program code 1018 may be transferred to data processing system 1000 using computer-readable signal media 1026. Computer-readable signal media 1026 may be, for example, a propagated data signal containing program code 1018. For example, computer-readable signal media 1026 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 1018 may be downloaded over a network to persistent storage 1008 from another device or data processing system through computer-readable signal media 1026 for use within data processing system 1000. For instance, program code stored in a computer-readable storage medium in a server data processing system may be downloaded over a network from the server to data processing system 1000. The data processing system providing program code 1018 may be a server computer, a client computer, or some other device capable of storing and transmitting program code 1018.

The different components illustrated for data processing system 1000 are not meant to provide architectural limitations to the manner in which different embodiments may be implemented. The different illustrative embodiments may be implemented in a data processing system including components in addition to or in place of those illustrated for data processing system 1000. Other components shown in FIG. 10 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 1004 may take the form of a hardware unit that has circuits that are manufactured or configured for a particular use. This type of hardware may perform operations without needing program code to be loaded into a memory from a storage device to be configured to perform the operations.

For example, when processor unit 1004 takes the form of a hardware unit, processor unit 1004 may be a circuit system, an application-specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 1018 may be omitted because the processes for the different embodiments are implemented in a hardware unit.

In still another illustrative example, processor unit 1004 may be implemented using a combination of processors found in different computers and hardware units. Processor unit 1004 may have a number of hardware units and a number of processors that are configured to run program code 1018. With this depicted example, some of the processes may be implemented in the number of hardware units, while other processes may be implemented in the number of processors.

In another example, a bus system may be used to implement communications framework 1002 and may be comprised of one or more buses, such as a system bus or an input/output bus. Of course, the bus system may be implemented using any suitable type of architecture that provides for a transfer of data between different components or devices attached to the bus system.

Additionally, a communications unit may include a number of more devices that transmit data, receive data, or transmit and receive data. A communications unit may be, for example, a modem or a network adapter, two network adapters, or some combination thereof. Further, a memory may be, for example, memory 1006, or a cache, such as found in an interface and memory controller hub that may be present in communications framework 1002.

Thus, illustrative embodiments of the present invention provide a method, apparatus, and computer program product for managing marketing impressions. A processor unit identifies utility of a seller and utility of a user. The processor unit may identify a reward and a social marketing task to be performed by the user for an activation of the reward in response to the request for the offer. The offer of the reward and the social marketing task may be sent by the processor unit to the user. The reward for the user may be activated by the processor unit when the social marketing task is completed.

The illustrative examples provide a personalized collaborative offer to increase marketing impressions for an item or an entity. For instance, an offer generated by a reward modeler comprises a personalized reward and associated social marketing task. The reward modeler uses a negotiation model based on marketing impression goals to define personalized offers acceptable and beneficial for a user and an entity selling the product or service. Thus, direct two-way communication between a user and an entity, such as a customer and a seller, is provided in defining an offer.

Moreover, the social marketing task associated with each reward is easily ascertainable, which makes status monitoring and renegotiation of offers much easier than with currently used systems. In this manner, an entity may increase both marketing impressions and the redemption rate of rewards. As a result, entities will sell more products and services.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing marketing impressions, the method comprising:
generating, by a processor unit, an offer of a reward for performing a social marketing task, wherein the social marketing task is for generating a first number of marketing impressions to achieve a set of objectives of a seller, and wherein the reward and the social marketing task are identified, by the processor unit, based on utility of the seller and utility of a user; and
activating, by the processor unit, the reward for the user based on a determination that the user has accepted the offer and a determination that performing of the social marketing task has generated the first number of marketing impressions.

2. The method of claim 1, wherein the social marketing task is to be performed by at least one of the user, members of a social network of the user, and other users not in the social network of the user.

3. The method of claim 1, wherein the set of objectives of the seller comprises at least one of marketing impression objectives, profit margin objectives, product value objectives, or product profile objectives, wherein the utility of the seller is a value to the seller associated with achieving the set of objectives of the seller, and wherein the utility of the seller is determined, by the processor unit, based on the value to the seller for rewards offered to users.

4. The method of claim 1, wherein the utility of the user is determined, by the processor unit, based on a set of characteristics comprising at least one of social influence, item preference, or shopping history of the user.

5. The method of claim 1, further comprising:
sending, by the processor unit, the offer of the reward for performing the social marketing task to the user in response to at least one of user input from the user requesting the offer, user input from a member of a social network of the user requesting the offer be sent to the user, a request from the seller to send the offer to the user, and user input from a third party requesting the offer be sent to the user.

6. The method of claim 1, wherein the generating step further comprises:
identifying, by the processor unit, a number of rewards;
identifying, by the processor unit, a group of social marketing tasks corresponding to the number of rewards;
presenting, by the processor unit, the number of rewards and the group of social marketing tasks; and
identifying, by the processor unit, the reward and the social marketing task in response to user input selecting the reward.

7. The method of claim 1, wherein the identifying step comprises:
negotiating, by the processor unit, between the user and the seller offering the reward to select the reward and the social marketing task.

8. The method of claim 7, wherein the reward is a first reward, the social marketing task is a first social marketing task, and the negotiating step comprises:
receiving, by the processor unit, user input of a second reward and a second social marketing task; and
identifying, by the processor unit, at least one of an acceptance of the second reward and the second social marketing task, a rejection of the second reward and the second social marketing task, or a third reward and a third social marketing task to be performed by the user; and
sending, by the processor unit, at least one of the acceptance, the rejection, or the third reward and the third social marketing task to the user.

9. The method of claim 1, further comprising:
determining, by the processor unit, a status of the social marketing task.

10. The method of claim 9, wherein the reward is a first reward, the social marketing task is a first social marketing task, and the sending step comprises:
sending, by the processor unit, an updated offer for a second reward and a second social marketing task based on the status of the first social marketing task.

11. The method of claim 1, wherein the social marketing task is selected from at least one of liking a page, sending a message, commenting on a product or service, writing a review, posting on a blog, contacting an entity, organizing a meeting, trying a product or service, or visiting a website.

12. The method of claim 1, wherein the reward is selected from at least one of a discount, free shipping, a product, or a service.

13. An apparatus for managing marketing impressions comprising:
a number of processor units, a memory, and a number of computer-readable storage devices;
first program instructions to identify utility of a seller, identify utility of a user, and generate an offer of a reward, based on the utility of the seller and the utility of the user, for performing a social marketing task, wherein the social marketing task is for generating a first number of marketing impressions to achieve a set of objectives of the seller; and
second program instructions to activate the reward for the user based on a determination that the user has accepted the offer and a determination that performing of the social marketing task has generated the first number of marketing impressions, wherein the first program instructions and the second program instructions are stored in the number of computer-readable storage devices for processing by the number of processor units via the memory.

14. The apparatus of claim 13, wherein the social marketing task is to be performed by at least one of the user, members of a social network of the user, and other users not in the social network of the user.

15. The apparatus of claim 13, further comprising:
third program instructions to send the offer of the reward for performing the social marketing task to the user in response to at least one of user input from the user requesting the offer, user input from a member of a social network of the user requesting the offer be sent to the user, a request from the seller to send the offer to the user, and user input from a third party requesting the offer be sent to the user, wherein the third program instructions are stored in the number of computer-readable storage devices for processing by the number of processor units via the memory.

16. The apparatus of claim 13, wherein the first program instructions to generate the offer of the reward for performing the social marketing task comprise:
program instructions to identify a number of rewards;
program instructions to identify a group of social marketing tasks corresponding to the number of rewards;
program instructions to present the number of rewards and the group of social marketing tasks; and
program instructions to identify the reward and the social marketing task in response to user input selecting the reward.

17. The apparatus of claim 13, wherein the first program instructions to generate the offer of the reward for performing the social marketing task comprise:
program instructions to communicate with the user and the seller to select the reward and the social marketing task.

18. The apparatus of claim 13, wherein the social marketing task is selected from at least one of liking a page, sending a message, commenting on a product or service, writing a review, posting on a blog, contacting an entity, organizing a meeting, trying a product or service, or visiting a website.

19. The apparatus of claim 13, wherein the reward is selected from at least one of a discount, free shipping, a product, or a service.

20. A computer program product for managing marketing impressions comprising:
a computer-readable storage device;
program instructions, stored on the computer-readable storage device, for identifying utility of a seller, identifying utility of a user, and generating an offer of a reward, based on the utility of the seller and the utility of the user, for performing a social marketing task, wherein the social marketing task is for generating a first number of marketing impressions to achieve a set of objectives of the seller; and
program instructions, stored on the computer-readable storage device, for activating the reward for the user based on a determination that the user has accepted the offer and a determination that performing of the social marketing task has generated the first number of marketing impressions.
